(19) United States
(12) Patent Application Publication
(10) Pub. No.: US 2024/0381019 A1
(43) Pub. Date: Nov. 14, 2024

(54) Systems, Devices, and/or Methods for Managing Audio Learning

(71) Applicant: Jessica Alvis, Waynesboro, VA (US)

(72) Inventor: Jessica Alvis, Waynesboro, VA (US)

(21) Appl. No.: 18/197,091

(22) Filed: May 14, 2023

(51) Int. Cl. H04R 1/10; G06F 3/16; G10L 19/00

(52) U.S. Cl. CPC H04R 1/1066; G06F 3/16; G10L 19/0018; H04R 1/1041; H04R 1/1091; H04R 2201/103

(57) ABSTRACT

Certain exemplary embodiments can provide an earpiece and a first end piece. A body of the earpiece has a cuboid shape with edges of the cuboid shape beveled so as to lack corners that form right angles. A first end of the earpiece has a first circular surface. A second end of the earpiece has a second circular surface. The first end piece is coupled to the first end of the earpiece. The first end piece comprises a dome shaped surface.

### BRIEF DESCRIPTION OF THE DRAWINGS

A wide variety of potential practical and useful embodiments will be more readily understood through the following detailed description of certain exemplary embodiments, with reference to the accompanying exemplary drawings in which:

FIG. 1 is a side view of an exemplary embodiment of a system 1000;

FIG. 2 is a perspective view of an exemplary embodiment of an earpiece 2000;

FIG. 3 is a side view of earpiece 2000;

FIG. 4 is a side view of earpiece 2000;

FIG. 5 is an end view of earpiece 2000;

FIG. 6 is an end view of earpiece 2000;

FIG. 7 is a top view of earpiece 2000;

FIG. 8 is a bottom view of earpiece 2000;

FIG. 9 is a perspective view of an exemplary embodiment of an earpiece body;

FIG. 10 is a block diagram of an exemplary embodiment of a system 10000;

FIG. 11 is a block diagram of an exemplary embodiment of an information device 11000;

FIG. 12 is a flowchart of an exemplary embodiment of a method 12000;

FIG. 13 is a perspective view of an exemplary embodiment of an earpiece 13000; and

FIG. 14 is a side view of an exemplary embodiment of an earpiece end piece 14000.

### DETAILED DESCRIPTION

Certain exemplary embodiments can provide an earpiece and a first end piece. A body of the earpiece has a cuboid shape with edges of the cuboid shape beveled so as to lack corners that form right angles. A first end of the earpiece has a first circular surface. A second end of the earpiece has a second circular surface. The first end piece is coupled to the first end of the earpiece. The first end piece comprises a dome shaped surface.

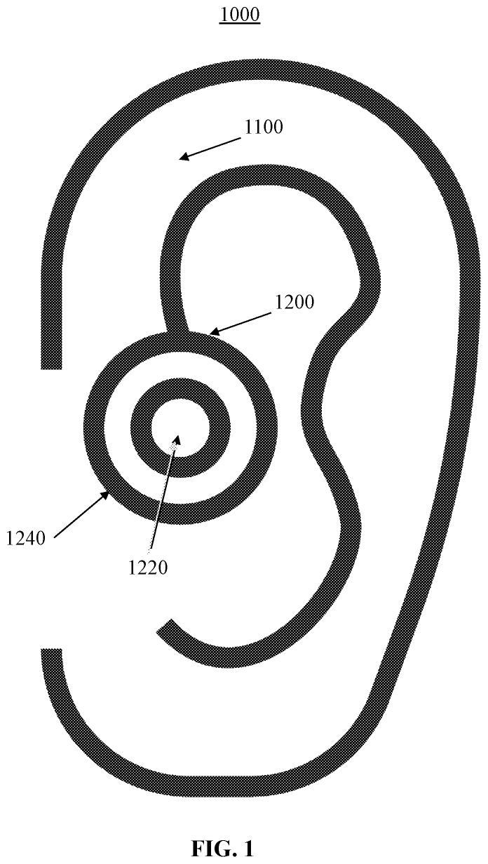

FIG. 1 is a side view of an exemplary embodiment of a system 1000, which illustrates a representation of a human ear 1100, an earpiece 1200, an earpiece cap 1220, and an earpiece body 1240. Earpiece 1200 is inserted into human ear 1100. Earpiece 1200 is constructed to play audio from at least one book and/or translate audio from a first language to a second language.

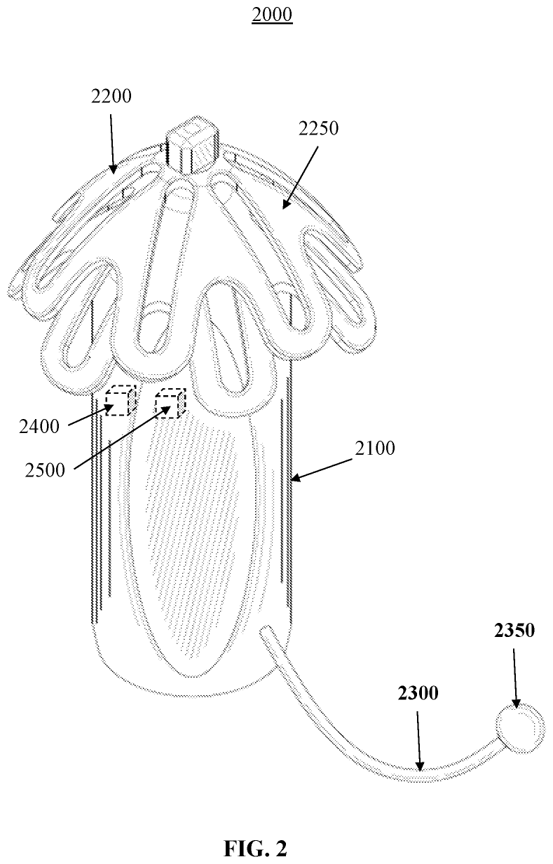

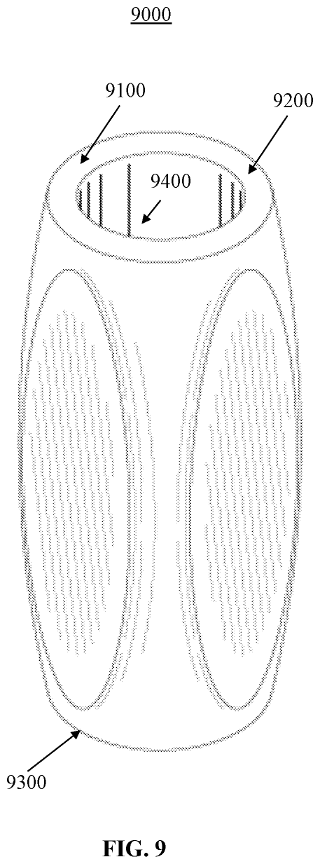

FIG. 2 is a perspective view of an exemplary embodiment of an earpiece 2000. A body 2100 of earpiece 2000 has a cuboid shape with edges of body 2100 beveled so as to lack corners that form right angles. A first end (see first end 9100 of FIG. 9) of body 2100 has a first circular surface (see first circular surface 9200 of FIG. 9). A second end of body 2100 has a second circular surface (see second circular surface 9900 of FIG. 9).

Earpiece 2000 comprises a first end piece 2200. First end piece 2200 is coupled to first end of body 2100. First end piece 2200 comprises a dome shaped surface 2250. Earpiece 2000 is constructed to:
play audio from at least one book; and/or
translate audio from a first language to a second language.

The at least one book can be downloaded from a cellular telephone, a tablet,
and/or an information device, etc. In certain exemplary embodiments, a user can:
start and/or stop audio to earpiece 2000 from the at least one book via the cellular telephone; and/or
adjust volume of the audio from the at least one book via the cellular telephone.

Earpiece 2000 comprises a second end piece 2300. Second end piece 2300 is coupled to the second end (see second end 9300 of FIG. 9) of body 2100. Second end piece 2300 comprises a gripper 2350. A user can remove earpiece 2000 from an ear of a human via gripper 2350. Gripper 2350 is constructed to be touched by human fingers to remove earpiece 2000 from an ear of a human.

Earpiece 2000 can comprise:
a memory device 2400; and/or
a sound converter 2500.

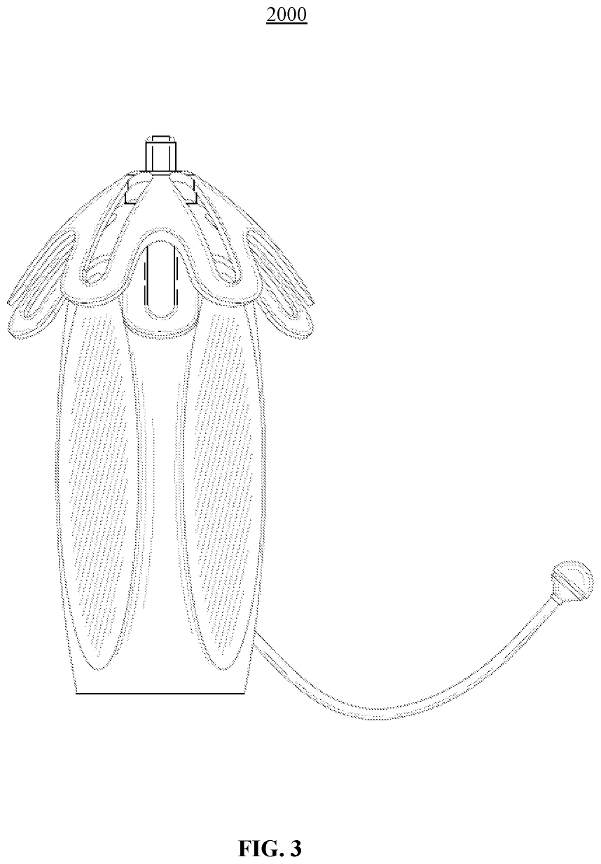

FIG. 3 is a side view of earpiece 2000.

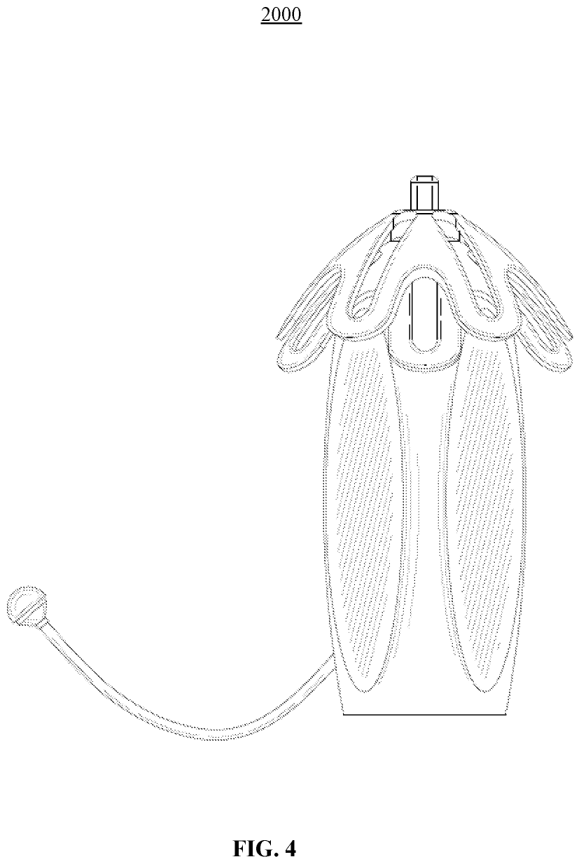

FIG. 4 is a side view of earpiece 2000.

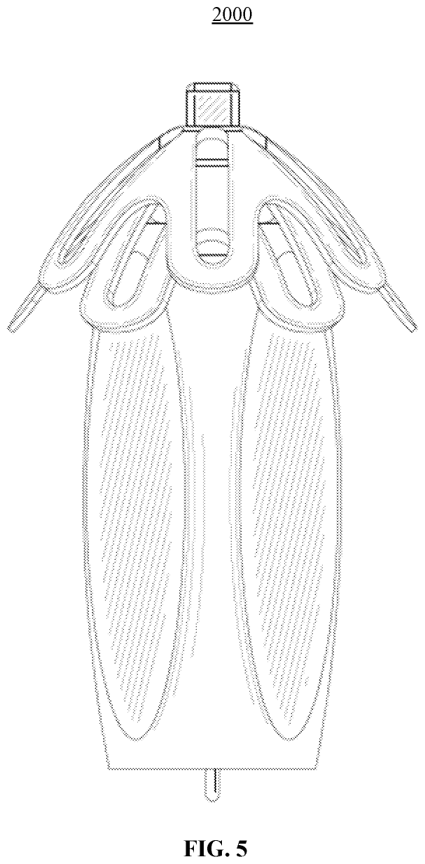

FIG. 5 is an end view of earpiece 2000.

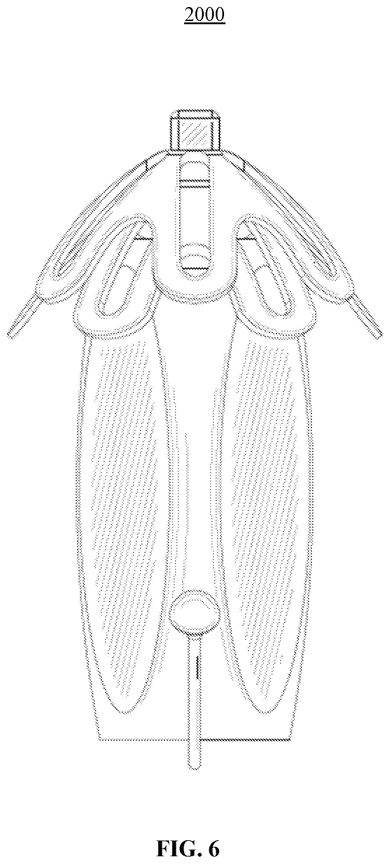

FIG. 6 is an end view of earpiece 2000;

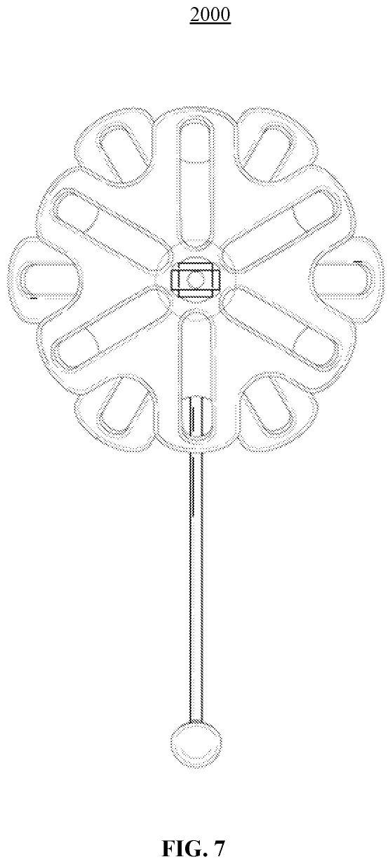

FIG. 7 is a top view of earpiece 2000;

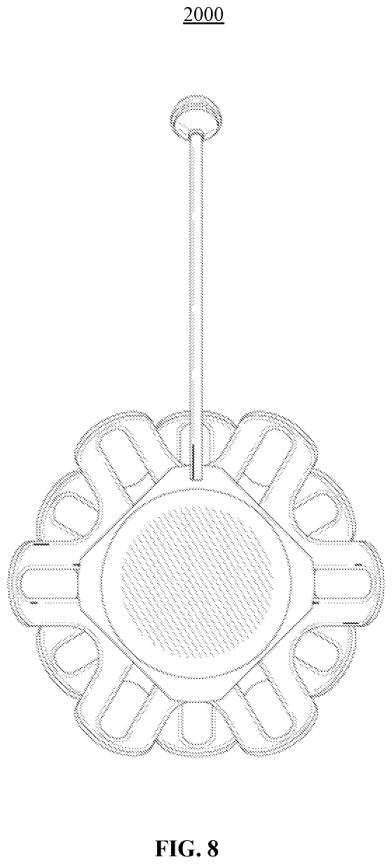

FIG. 8 is a bottom view of earpiece 2000;

FIG. 9 is a perspective view of an exemplary embodiment of an earpiece body 9000. Earpiece body 9000 comprises a first end 9100, a first circular surface 9200, and a second end 9300. Earpiece body 9000 can define a cavity 9400.

In certain exemplary embodiments, earpiece body 9000 can have the following approximate dimensions in millimeters:
an overall length of 12.88;
a thickness of 6.0; and
a diameter of first circular surface 9200 of 6.0.

In other exemplary embodiments, earpiece body 9000 can have variations in dimensions.

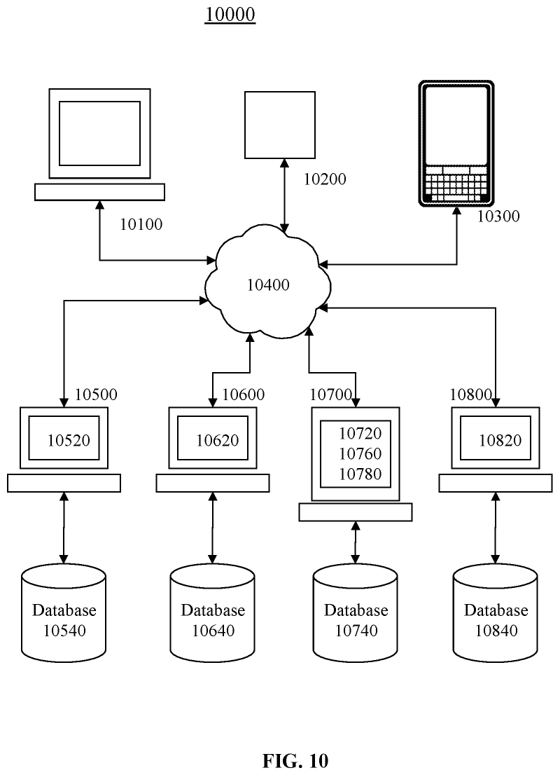

FIG. 10 is a block diagram of an exemplary embodiment of a system 10000, which can comprise a smartphone 10300, an information device 10100, tablet 10200, a network 10400, a first server 10500, a second server 10600, a third server 10700, and a fourth server 10800. First server 10500 can comprise a first user interface 10520 and can be coupled to a first database 10540. Second server 10600 can comprise a second user interface 10620 and can be coupled to a second database 10640. Third server 10700 can comprise a third user interface 10720, a processor 10760, machine instructions 10780, and can be coupled to a third database 10740. Fourth server 10800 can comprise a fourth user interface 10820 and can be coupled to a fourth database 10840. Any of the methods and/or steps thereof can be carried out in whole or in part by tablet 10200, smartphone 10300, information device 10100 and/or first server 10500. Second server 10600, third server 10700, and/or fourth server 10800 can each be associated with implementation of a system via which audio is provided to an earpiece. In certain exemplary embodiments, system 10000 can be used to implement one or more methods disclosed herein.

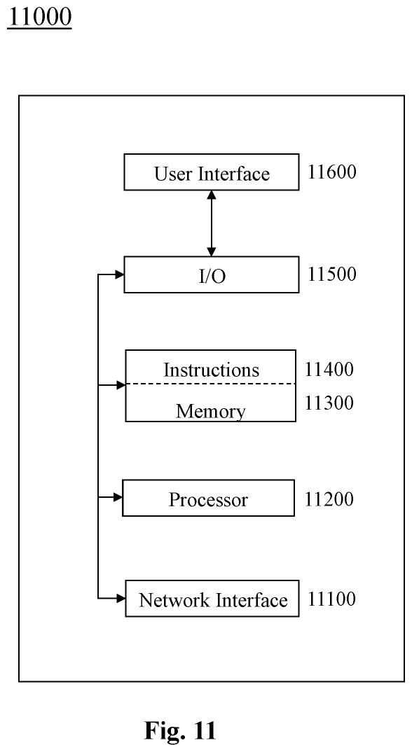

FIG. 11 is a block diagram of an exemplary embodiment of an information device 11000, which in certain operative embodiments can comprise, for example, first server 10500, information device 10100, and/or smartphone 10300 of FIG. 10. Information device 11000 can comprise any of numerous circuits and/or components, such as for example, one or more network interfaces 11100, one or more processors 11200, one or more memories 11300 containing instructions 11400, one or more input/output devices 11500, and/or one or more user interfaces 11600 coupled to one or more input/output devices 11500, etc.

In certain exemplary embodiments, via one or more user interfaces 2600, such as a graphical user interface, a user can view a rendering of information related to researching, designing, modeling, creating, developing, building, manufacturing, operating, maintaining, storing, marketing, selling, delivering, selecting, specifying, requesting, ordering, receiving, returning, rating, and/or recommending any of the products, services, methods, and/or information described herein.

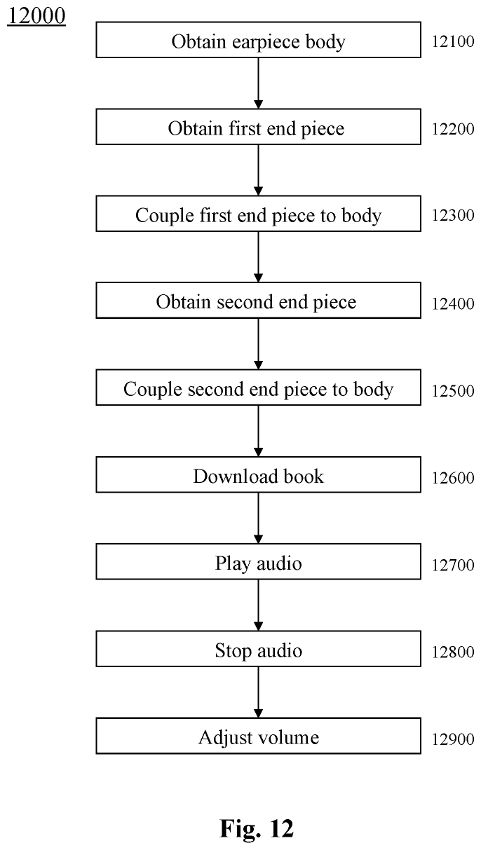

FIG. 12 is a flowchart of an exemplary embodiment of a method 12000. At activity 12100, an earpiece body is made. The earpiece body has a cuboid shape with edges of the cuboid shape beveled so as to lack corners. A first end of the earpiece body has a first circular surface. A second end of the earpiece body has a second circular surface.

At activity 12200, a first end piece is made.

At activity 12300, the first end piece is coupled to the first end of the earpiece body. The first end piece comprises a dome shaped surface.

At activity 12400, a second end piece is made.

At activity 12500, the second end piece is coupled to the second end of the earpiece body. The second end piece comprises a gripper; wherein a user can remove the earpiece from an ear of a human via the gripper.

At activity 12600, an audio from at least one book is downloaded to the earpiece. For example, the at least one book is downloaded to the earpiece from a cellular telephone.

At activity 12700, audio play in the earpiece is started. For example, the audio play can be started via the cellular telephone.

At activity 12800, audio play in the earpiece is stopped. For example, the audio play can be stopped via the cellular telephone.

At activity 12900, audio play volume is adjusted. For example, the audio play volume is adjusted via the cellular telephone.

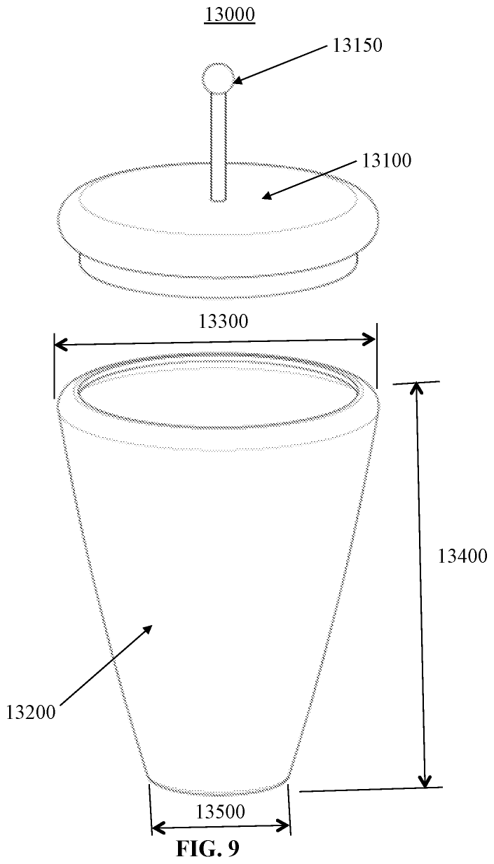

FIG. 13 is a perspective view of an exemplary embodiment of an earpiece 13000, which comprises a body 13100 and an end piece 13200. Insert 13100 has a cap diameter 13300, a height 13400, and a base diameter 13500. In certain exemplary embodiments, cap diameter 13300 can be approximately 10.0 millimeters. In certain exemplary embodiments, height 13400 can be approximately 12.88 millimeters. In certain exemplary embodiments, base diameter 13500 can be approximately 4.5 millimeters.

Body 13100 of earpiece 13000 has a cone frustum shape with edges of body 13100 beveled so as to lack corners that form right angles. A first end of body 13100 has a first circular surface. A second end of body 13100 has a second circular surface. End piece 13200 is coupled to the first end of body 13100. The end piece comprises a gripper 13150. System 130001 s constructed to:
play audio from at least one book; and/or
translate audio from a first language to a second language.

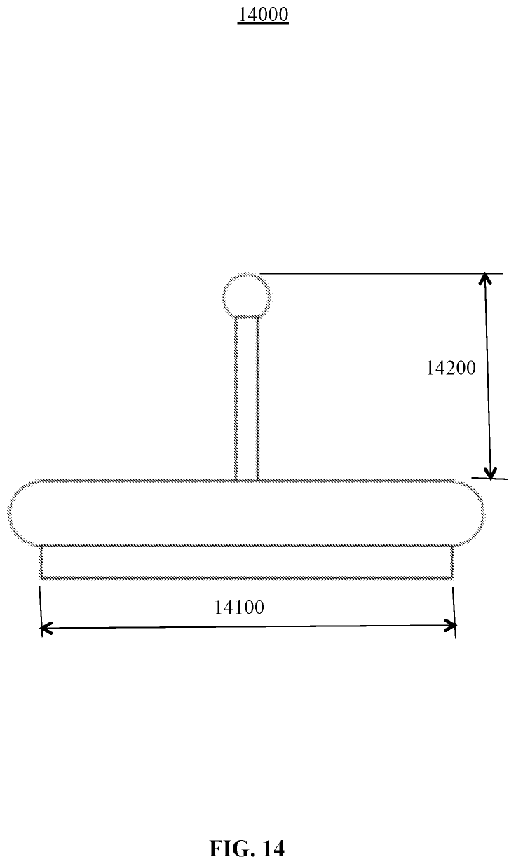

FIG. 14 is a side view of an exemplary embodiment of an earpiece end piece 14000. End piece 14000 has a diameter 14100 and a height 14200. In certain exemplary embodiments, diameter 14100 can be approximately 8.9 millimeters. In certain exemplary embodiments, height 14200 can be approximately 4.5 millimeters.

Certain exemplary embodiments can comprise two earpieces that are nearly invisible. The inventor calls such earpieces “College Bugz”. The earpieces are constructed to store at least one full college book at a time. The earpieces can be communicatively coupled to application software (the “App”), which comprises machine instructions executed via an information device. The App is constructed to load and/or overwrite textbooks in the earpieces. Once a textbook is downloaded, the earpieces do not need to communicate with any information device (e.g., phone, tablet, or computer) in order for the earpieces to provide a user the ability to listen to textbook content. The earpieces are constructed to stop in short sections as the textbook is being read to ask five to ten questions concerning recent textbook content. If a user does not answer all questions correctly, the earpieces replay the most recent short section and repeats the questions until the user answers all questions correctly. Once the user answers all questions correctly, the earpieces play the next short section of the textbook being played. The questions can be multiple choice questions with answers such as A, B, C, or D. The user can adjust the volume of the earpieces and can be constructed to allow the user to start and stop the playing of the textbook. The earpieces can be turned off while batteries of the earpieces are being charged. The earpieces can be constructed to be automatically turned on when the earpieces are not electrically coupled to a charger. While utilizing the earpieces, the user can select answers to questions, make notes concerning a textbook being played, highlight portions of the textbook, and track progress of listening to the textbook. The user can keep books that have been downloaded to the App that the user is utilizing. In certain exemplary embodiments, the earpieces are provided with the charger. Certain exemplary embodiments assist students in comprehending content of textbooks.

The App can be constructed to:
download books selected by a user;
provide a user interface via which the user highlights words while reading a textbook, to be able to follow along;
download books and store books;
allows the user follow along with books while the user is listening to books;
accept answers to questions (e.g., multiple choice questions, A thru D);
tracks progress of the user (e.g., tell the user how many times the user took each test and from which book);
retains a place in the book last listened to by the user, so the user can go back and pick up where the user left off;
require the user to correctly all test questions before allowing the user to move on to a next section of a book;
if the user does not answer all questions correctly, to replay a previous book section again; and/or
can allow the user to delete a stored book on College Bugz and replace the stored book with new book of chosen by the user.

The College Bugz (e.g., a pair) can be constructed to:
store at least one book at a time in a memory device;
have volume control;
can comprise a rechargeable battery;
can comprise an off and on control (e.g., a switch);
can comprise a control to pause and/or start playing a book;
retains a location in a book most recently reviewed by the user such that the user can start back up where the user left off a last time that the playing of a book has been paused or turned off;
accept answers to questions (e.g., multiple choice questions, A thru D);
be communicatively coupled to an App and communicate therewith;
recognize a voice of the user
utilize interchangeable ear cups.

College Bugz can be provided with:
pair of College Bugz;
three to four sets of interchangeable cups;
a charging case;

The charging case can be:
as small as possible (possibly having a square or rectangular cross section); and/or
constructed to allow the College Bugz to slide into and/or be pushed out of a first side.

The charging case can comprise an opposite side, which opposite side is constructed to slide to a partially open (to push out) position. Certain exemplary embodiments can define a charging hole on a partially open side.

Certain exemplary embodiments do not need a case to recharge a battery. Where a case is provided, the case can clip on to the College Bugz. In certain exemplary embodiments, the charging base can render an indication of how charged College Bugz batteries are. In certain exemplary embodiments, magnets can be utilized to hold College Bugz in place. Certain exemplary embodiments cause a green light to illuminate when the College Bugz are electrically coupled to the charging case.

### Definitions

When the following terms are used substantively herein, the accompanying definitions apply. These terms and definitions are presented without prejudice, and, consistent with the application, the right to redefine these terms during the prosecution of this application or any application claiming priority hereto is reserved. For the purpose of interpreting a claim of any patent that claims priority hereto, each definition (or redefined term if an original definition was amended during the prosecution of that patent), functions as a clear and unambiguous disavowal of the subject matter outside of that definition.
a—at least one.
activity—an action, act, step, and/or process or portion thereof.
adapted to—made suitable or fit for a specific use or situation.
adapter—a device used to effect operative compatibility between different parts of one or more pieces of an apparatus or system.
adjust—to change to a sought state.
and/or—either in conjunction with or in alternative to.
apparatus—an appliance or device for a particular purpose.
associate—to join, connect together, and/or relate.
audio—a noise that can be heard by a human or animal.
automatically—acting or operating in a manner essentially independent of external influence or control. For example, an automatic light switch can turn on upon “seeing” a person in its view, without the person manually operating the light switch.
bevel—(n) a slanted surface, wherein the surface is slanted at less than a right angle; (v) to create a slanted surface, wherein the surface is slanted at less than a right angle.
body—a largest or principal part of an object.
book—a literary work.
can—is capable of, in at least some embodiments.
cause—to produce an effect.
cellular telephone—an information device that is constructed to make telephone calls that people can take with them and use inside and/or outside their homes.
circuit—an electrically conductive pathway and/or a communications connection established across two or more switching devices comprised by a network and between corresponding end systems connected to, but not comprised by the network.
circular—having a shape of a closed plane curve, every point of which is substantially equidistant from a fixed point within the curve.
comprising—including but not limited to.
configure—to make suitable or fit for a specific use or situation.
connect—to join or fasten together.
constructed to—made to and/or designed to.
convert—to transform, adapt, and/or change.
corner—a junction at which two converging surfaces meet.
couple—to link in some fashion.
coupleable—capable of being joined, connected, and/or linked together.
create—to bring into being.
cuboid—a three-dimensional shape with faces that are at least partially planar. Cuboids have six faces that are joined to adjacent sides of the three-dimensional shape, wherein planes defined by each of the six faces are substantially perpendicular to adjacent sides.
data—distinct pieces of information, usually formatted in a special or predetermined way and/or organized to express concepts.
define—to establish the outline, form, or structure of.
determine—to obtain, calculate, decide, deduce, and/or ascertain.
device—a machine, manufacture, and/or collection thereof.
dome—a rounded surface that has a shape resembling a portion of a ball.
download—to transferring data from a first memory device to a second memory device.
ear—a hearing organ of a human.
earpiece—a device that is placed against or inserted into the outer opening of the ear that transmits sounds.
edge—an outside limit of an object, area, or surface.
end—a most extreme part of an object.
estimate—to calculate and/or determine approximately and/or tentatively.
finger—a digit of a human hand.
cone frustum shape—a portion of a cone that remains after its upper part has been cut off by a plane parallel to its base.
generate—to create, produce, give rise to, and/or bring into existence.
gripper—a protruding portion of an object that can be grabbed by a human hand.
haptic—involving the human sense of kinesthetic movement and/or the human sense of touch. Among the many potential haptic experiences are numerous sensations, body-positional differences in sensations, and time-based changes in sensations that are perceived at least partially in non-visual, non-audible, and non-olfactory manners, including the experiences of tactile touch (being touched), active touch, grasping, pressure, friction, traction, slip, stretch, force, torque, impact, puncture, vibration, motion, acceleration, jerk, pulse, orientation, limb position, gravity, texture, gap, recess, viscosity, pain, itch, moisture, temperature, thermal conductivity, and thermal capacity.
human—a member of the species Homo sapiens.
information device—any device capable of processing data and/or information, such as any general purpose and/or special purpose computer, such as a personal computer, workstation, server, minicomputer, mainframe, supercomputer, computer terminal, laptop, wearable computer, and/or Personal Digital Assistant (PDA), mobile terminal, Bluetooth device, communicator, “smart” phone (such as a Treo-like device), messaging service (e.g., Blackberry) receiver, pager, facsimile, cellular telephone, a traditional telephone, telephonic device, a programmed microprocessor or microcontroller and/or peripheral integrated circuit elements, an ASIC or other integrated circuit, a hardware electronic logic circuit such as a discrete element circuit, and/or a programmable logic device such as a PLD, PLA, FPGA, or PAL, or the like, etc. In general any device on which resides a finite state machine capable of implementing at least a portion of a method, structure, and/or or graphical user interface described herein may be used as an information device. An information device can comprise components such as one or more network interfaces, one or more processors, one or more memories containing instructions, and/or one or more input/output (I/O) devices, one or more user interfaces coupled to an I/O device, etc.
initialize—to prepare something for use and/or some future event.
input/output (I/O) device—any sensory-oriented input and/or output device, such as an audio, visual, haptic, olfactory, and/or taste-oriented device, including, for example, a monitor, display, projector, overhead display, keyboard, keypad, mouse, trackball, joystick, gamepad, wheel, touchpad, touch panel, pointing device, microphone, speaker, video camera, camera, scanner, printer, haptic device, vibrator, tactile simulator, and/or tactile pad, potentially including a port to which an I/O device can be attached or connected.
install—to connect or set in position and prepare for use.
lack—to be substantially devoid of.
language—a system of communication used by a particular country or community.
machine instructions—directions adapted to cause a machine, such as an information device, to perform one or more particular activities, operations, or functions. The directions, which can sometimes form an entity called a “processor”, “kernel”, “operating system”, “program”, “application”, “utility”, “subroutine”, “script”, “macro”, “file”, “project”, “module”, “library”, “class”, and/or “object”, etc., can be embodied as machine code, source code, object code, compiled code, assembled code, interpretable code, and/or executable code, etc., in hardware, firmware, and/or software.
machine readable medium—a physical structure from which a machine can obtain data and/or information. Examples include a memory, punch cards, etc.
make—to lay out and construct.
may—is allowed and/or permitted to, in at least some embodiments.
memory device—an apparatus capable of storing analog or digital information, such as instructions and/or data. Examples include a non-volatile memory, volatile memory, Random Access Memory, RAM, Read Only Memory, ROM, flash memory, magnetic media, a hard disk, a floppy disk, a magnetic tape, an optical media, an optical disk, a compact disk, a CD, a digital versatile disk, a DVD, and/or a raid array, etc. The memory device can be coupled to a processor and/or can store instructions adapted to be executed by processor, such as according to an embodiment disclosed herein.
method—a process, procedure, and/or collection of related activities for accomplishing something.
network—a communicatively coupled plurality of nodes. A network can be and/or utilize any of a wide variety of sub-networks, such as a circuit switched, public-switched, packet switched, data, telephone, telecommunications, video distribution, cable, terrestrial, broadcast, satellite, broadband, corporate, global, national, regional, wide area, backbone, packet-switched TCP/IP, Fast Ethernet, Token Ring, public Internet, private, ATM, multi-domain, and/or multi-zone sub-network, one or more Internet service providers, and/or one or more information devices, such as a switch, router, and/or gateway not directly connected to a local area network, etc.
network interface—any device, system, or subsystem capable of coupling an information device to a network. For example, a network interface can be a telephone, cellular phone, cellular modem, telephone data modem, fax modem, wireless transceiver, Ethernet card, cable modem, digital subscriber line interface, bridge, hub, router, or other similar device.
piece—a part of a larger device or system.
play—to emit sounds.
plurality—the state of being plural and/or more than one.
predetermined—established in advance.
processor—a device and/or set of machine-readable instructions for performing one or more predetermined tasks. A processor can comprise any one or a combination of hardware, firmware, and/or software. A processor can utilize mechanical, pneumatic, hydraulic, electrical, magnetic, optical, informational, chemical, and/or biological principles, signals, and/or inputs to perform the task(s). In certain embodiments, a processor can act upon information by manipulating, analyzing, modifying, converting, transmitting the information for use by an executable procedure and/or an information device, and/or routing the information to an output device. A processor can function as a central processing unit, local controller, remote controller, parallel controller, and/or distributed controller, etc. Unless stated otherwise, the processor can be a general-purpose device, such as a microcontroller and/or a microprocessor, such the Pentium IV series of microprocessor manufactured by the Intel Corporation of Santa Clara, California. In certain embodiments, the processor can be dedicated purpose device, such as an Application Specific Integrated Circuit (ASIC) or a Field Programmable Gate Array (FPGA) that has been designed to implement in its hardware and/or firmware at least a part of an embodiment disclosed herein.
project—to calculate, estimate, or predict.
provide—to furnish, supply, give, and/or make available.
receive—to get as a signal, take, acquire, and/or obtain.
recommend—to suggest, praise, commend, and/or endorse.
remove—to take something out of a space (e.g., to take something out of a human ear).
render—to make perceptible to a human, for example as data, commands, text, graphics, audio, video, animation, and/or hyperlinks, etc., such as via any visual, audio, and/or haptic means, such as via a display, monitor, electric paper, ocular implant, cochlear implant, speaker, etc.
repeatedly—again and again; repetitively.
request—to express a desire for and/or ask for.
select—to make a choice or selection from alternatives.
set—a related plurality.
shape—a spatial form.
signal—information, such as machine instructions for activities and/or one or more letters, words, characters, symbols, signal flags, visual displays, and/or special sounds, etc. having prearranged meaning, encoded as automatically detectable variations in a physical variable, such as a pneumatic, hydraulic, acoustic, fluidic, mechanical, electrical, magnetic, optical, chemical, and/or biological variable, such as power, energy, pressure, flowrate, viscosity, density, torque, impact, force, frequency, phase, voltage, current, resistance, magnetomotive force, magnetic field intensity, magnetic field flux, magnetic flux density, reluctance, permeability, index of refraction, optical wavelength, polarization, reflectance, transmittance, phase shift, concentration, and/or temperature, etc. Depending on the context, a signal and/or the information encoded therein can be synchronous, asynchronous, hard real-time, soft real-time, non-real time, continuously generated, continuously varying, analog, discretely generated, discretely varying, quantized, digital, broadcast, multicast, unicast, transmitted, conveyed, received, continuously measured, discretely measured, processed, encoded, encrypted, multiplexed, modulated, spread, de-spread, demodulated, detected, de-multiplexed, decrypted, and/or decoded, etc.
sound—vibrations that travel through the air or another medium and can be heard when they reach a person's or animal's ear.
start—to begin an action (e.g., to begin playing an audio recording).
store—to place, hold, and/or retain data, typically in a memory.
stop—to end an action (e.g., to end playing an audio recording).
substantially—to a great extent or degree.
support—to bear the weight of, especially from below.
surface—the outer boundary of an object or a material layer.
system—a collection of mechanisms, devices, machines, articles of manufacture, processes, data, and/or instructions, the collection designed to perform one or more specific functions.
touch—to contact something with a part of a human body.
translate—to change one or more expressions from one language into another.
user—any person, organization, process, device, program, protocol, and/or system that uses a device and/or service.
transmit—to send as a signal, provide, furnish, and/or supply.
user interface—any device for rendering information to a user and/or requesting information from the user. A user interface includes at least one of textual, graphical, audio, video, animation, and/or haptic elements. A textual element can be provided, for example, by a printer, monitor, display, projector, etc. A graphical element can be provided, for example, via a monitor, display, projector, and/or visual indication device, such as a light, flag, beacon, etc. An audio element can be provided, for example, via a speaker, microphone, and/or other sound generating and/or receiving device. A video element or animation element can be provided, for example, via a monitor, display, projector, and/or other visual device. A haptic element can be provided, for example, via a very low frequency speaker, vibrator, tactile stimulator, tactile pad, simulator, keyboard, keypad, mouse, trackball, joystick, gamepad, wheel, touchpad, touch panel, pointing device, and/or other haptic device, etc. A user interface can include one or more textual elements such as, for example, one or more letters, number, symbols, etc. A user interface can include one or more graphical elements such as, for example, an image, photograph, drawing, icon, window, title bar, panel, sheet, tab, drawer, matrix, table, form, calendar, outline view, frame, dialog box, static text, text box, list, pick list, pop-up list, pull-down list, menu, tool bar, dock, check box, radio button, hyperlink, browser, button, control, palette, preview panel, color wheel, dial, slider, scroll bar, cursor, status bar, stepper, and/or progress indicator, etc. A textual and/or graphical element can be used for selecting, programming, adjusting, changing, specifying, etc. an appearance, background color, background style, border style, border thickness, foreground color, font, font style, font size, alignment, line spacing, indent, maximum data length, validation, query, cursor type, pointer type, autosizing, position, and/or dimension, etc. A user interface can include one or more audio elements such as, for example, a volume control, pitch control, speed control, voice selector, and/or one or more elements for controlling audio play, speed, pause, fast forward, reverse, etc. A user interface can include one or more video elements such as, for example, elements controlling video play, speed, pause, fast forward, reverse, zoom-in, zoom-out, rotate, and/or tilt, etc. A user interface can include one or more animation elements such as, for example, elements controlling animation play, pause, fast forward, reverse, zoom-in, zoom-out, rotate, tilt, color, intensity, speed, frequency, appearance, etc. A user interface can include one or more haptic elements such as, for example, elements utilizing tactile stimulus, force, pressure, vibration, motion, displacement, temperature, etc.
via—by way of and/or utilizing.
volume—a loudness of sound.
weight—a value indicative of importance.

### Note

Still other substantially and specifically practical and useful embodiments will become readily apparent to those skilled in this art from reading the above-recited and/or herein-included detailed description and/or drawings of certain exemplary embodiments. It should be understood that numerous variations, modifications, and additional embodiments are possible, and accordingly, all such variations, modifications, and embodiments are to be regarded as being within the scope of this application.

Thus, regardless of the content of any portion (e.g., title, field, background, summary, description, abstract, drawing figure, etc.) of this application, unless clearly specified to the contrary, such as via explicit definition, assertion, or argument, with respect to any claim, whether of this application and/or any claim of any application claiming priority hereto, and whether originally presented or otherwise:
there is no requirement for the inclusion of any particular described or illustrated characteristic, function, activity, or element, any particular sequence of activities, or any particular interrelationship of elements;
no characteristic, function, activity, or element is “essential”;
any elements can be integrated, segregated, and/or duplicated;
any activity can be repeated, any activity can be performed by multiple entities, and/or any activity can be performed in multiple jurisdictions; and
any activity or element can be specifically excluded, the sequence of activities can vary, and/or the interrelationship of elements can vary.

Moreover, when any number or range is described herein, unless clearly stated otherwise, that number or range is approximate. When any range is described herein, unless clearly stated otherwise, that range includes all values therein and all subranges therein. For example, if a range of 1 to 10 is described, that range includes all values therebetween, such as for example, 1.1, 2.5, 3.335, 5, 6.179, 8.9999, etc., and includes all subranges therebetween, such as for example, 1 to 3.65, 2.8 to 8.14, 1.93 to 9, etc.

When any claim element is followed by a drawing element number, that drawing element number is exemplary and non-limiting on claim scope. No claim of this application is intended to invoke paragraph six of 35 USC 112 unless the precise phrase “means for” is followed by a gerund.

Any information in any material (e.g., a United States patent, United States patent application, book, article, etc.) that has been incorporated by reference herein, is only incorporated by reference to the extent that no conflict exists between such information and the other statements and drawings set forth herein. In the event of such conflict, including a conflict that would render invalid any claim herein or seeking priority hereto, then any such conflicting information in such material is specifically not incorporated by reference herein.

Accordingly, every portion (e.g., title, field, background, summary, description, abstract, drawing figure, etc.) of this application, other than the claims themselves, is to be regarded as illustrative in nature, and not as restrictive, and the scope of subject matter protected by any patent that issues based on this application is defined only by the claims of that patent.

What is claimed is:

1. A system comprising:
an earpiece, a body of the earpiece having a cuboid shape with edges of the body beveled so as to lack corners that form right angles, a first end of the body having a first circular surface, a second end of the body having a second circular surface;
a first end piece, the first end piece coupled to the first end of the body, the first end piece comprising a dome shaped surface;
wherein, the system is constructed to:
play audio from at least one book; and
translate audio from a first language to a second language.

2. The system of claim 1, further comprising:
a second end piece, the second end piece coupled to the second end of the body, the second end piece comprising gripper, wherein a user removes the earpiece from an ear of a human via the gripper.

3. The system of claim 1, wherein:
the earpiece comprises a memory device.

4. The system of claim 1, wherein:
the earpiece comprises a sound converter.

5. The system of claim 1, further comprising:
a second end piece, the second end piece coupled to the second end of the body, the second end piece comprising gripper, wherein a user removes the earpiece from an ear of a human via the gripper, and wherein the gripper is constructed to be touched by human fingers to remove the earpiece from the ear of the human.

6. The system of claim 1, wherein:
the audio from the at least one book is downloaded from a cellular telephone.

7. The system of claim 1, wherein:
a user starts and stops the audio from the at least one book via a cellular telephone.

8. The system of claim 1, wherein:
a user adjusts volume of the audio from the at least one book via a cellular telephone.

9. The system of claim 1, wherein:
the audio from the at least one book is downloaded from an information device.

10. A method comprising:
making an earpiece body, the earpiece body having a cuboid shape with edges of the cuboid shape beveled so as to lack corners, a first end of the earpiece body having a first circular surface, a second end of the earpiece body having a second circular surface.

11. The method of claim 10, further comprising:
making an end piece, the end piece coupled to the first end of the earpiece body, the end piece comprising a dome shaped surface.

12. The method of claim 10, further comprising:
making an end piece, the end piece coupled to the second end of the earpiece body, the end piece comprising gripper, wherein a user removes an earpiece comprising the earpiece body from an ear of a human via the gripper.

13. The method of claim 10, further comprising:
coupling the earpiece body to an end piece, the end piece coupled to the first end of the earpiece body, the end piece comprising a dome shaped surface.

14. The method of claim 10, further comprising:
coupling the earpiece body to an end piece, the end piece coupled to the second end of the earpiece body, the end piece comprising gripper, wherein a user removes an earpiece comprising the earpiece body from an ear of a human via the gripper.

15. The method of claim 10, further comprising:
downloading audio from at least one book to an earpiece from a cellular telephone, the earpiece comprising the earpiece body.

16. The method of claim 10, further comprising:
starting audio play in an earpiece via a cellular telephone, the earpiece comprising the earpiece body.

17. The method of claim 10, further comprising:
stopping audio from playing in an earpiece via a cellular telephone, the earpiece comprising the earpiece body.

18. The method of claim 10, further comprising:
adjusting volume of audio play in an earpiece via a cellular telephone, the earpiece comprising the earpiece body.

19. A system comprising:
an earpiece, a body of the earpiece having a cone frustum shape with edges of the body beveled so as to lack corners that form right angles, a first end of the body having a first circular surface, a second end of the body having a second circular surface;
an end piece, the end piece coupled to the first end of the body, the end piece comprising a gripper;
wherein, the system is constructed to:
play audio from at least one book; and
translate audio from a first language to a second language.
